(19) United States
(12) Patent Application Publication
(10) Pub. No.: US 2009/0279721 A1
(43) Pub. Date: Nov. 12, 2009

(54) SPEAKER DEVICE

(75) Inventor: Shoji Tanaka, Hyogo (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Kadoma-shi, Osaka (JP)

(21) Appl. No.: 12/296,472

(22) PCT Filed: Apr. 9, 2007
(86) PCT No.: PCT/JP2007/057855

§ 371 Date: Oct. 8, 2008

(30) Foreign Application Priority Data
Apr. 10, 2006 (JP) 2006-107371

(51) Int. Cl. H04R 5/02

(52) U.S. Cl. 381/303; 381/98

(57) ABSTRACT

A speaker device includes first speaker units 2 and 5 and second speaker units 3 and 6 that are arranged symmetrically as viewed from a listening center axis X1-X2. The first speaker units 2 and 5 emit sounds in inward directions and reproduces at least the mid-range and above, and the second speaker units 3 and 6 emit sounds in a front direction and attenuates the treble range. With respect to a listening position in a front direction of one of the speaker systems 1 and 4, a sound arriving to the listening position from the first speaker unit of the speaker system located closer to the listening position, and a sound arriving thereto from the second speaker unit of the same speaker system, are destructive to each other in the mid-range due to a phase difference, whereby a sound pressure in the mid-range arriving from the speaker system located closer to the listening position is attenuated more, as compared with a sound pressure in the mid-range arriving from the speaker system located farther from the listening position. It is possible to achieve an excellent effect of expanding a listening position range for obtaining the center sound image localization, the natural sound quality without sense of discomfort, the large sound pressure reproduction, and the downsizing.

### TECHNICAL FIELD

The present invention relates to a speaker device for use in a movie multichannel sound reproduction equipment such as a stereophonic reproduction equipment or a so-called home theater system.

### BACKGROUND ART

Generally, in order to achieve excellent sound image localization in stereophonic reproduction, the listening position has to be at the midmost position between fight and left speakers. In other words, if the listening position is deviated from the midmost, closer to one of the speakers, reproduced sound such as a singing voice or another sound that should be heard from the vicinity of the midpoint between the fight and left speakers is heard from the speaker closer to the listening position, whereby sound images are biased toward the speaker closer to the listening position. This is well known.

Further, in order to reproduce movie multichannel in a so-called home theater system, a method is available in which a center channel signal is reproduced by right and left front speakers without installing a center speaker. This is, in other words, a method in which center channel signals are divided equally toward right and left front speakers and are superimposed on front channel signals.

Although this method has an advantage that there is no need to install an independent center speaker, the listening range where excellent sound image localization of center channel audio signals can be achieved is limited to the midmost area between the right and left front speakers, as is the case with the stereophonic reproduction.

In the case of the home theater reproduction in particular, it is desired that sound images of center channel audio signals are localized in the vicinity of the center of a screen, so that sounds and video images match each other. In the case where center channel signals are reproduced by right and left speakers as described above, if the listening position is deviated from the midmost area, sound images of voice such as speech on the center channel are localized at positions extremely deviated from the screen center, which causes a listener to feel sense of discomfort. Thus, natural reproduction of movies cannot be performed.

This is described below with reference to FIG. 20. FIG. 20 is an explanatory view illustrating the effect of a conventional speaker device, in which a left-hand speaker system 63 and a right-hand speaker system 64 are arranged at positions symmetrical with respect to a listening center axis X1-X2. The drawing shows a case where a display 67 is installed at the center, while a listening position P is deviated leftward.

Sound emitted by a speaker unit 65 of the left-side speaker system 63 and sound emitted by a speaker unit 66 of the right-side speaker system 64 form a synthetic sound pressure vector Vt at the listening position P. The right-side speaker unit 66 is farther from the listening position P than the left-side speaker unit 65 is, and the direction thereof is oblique. Therefore, a sound pressure vector V2 of the right-side speaker unit 66 at the listening position P is made significantly smaller than a sound pressure vector V1 of the left-side speaker unit 65 by the attenuation due to distance and the directivity.

Therefore, in the synthetic sound pressure vector Vt, the sound pressure vector V1 of the left-side speaker unit 65 is dominant, whereby a sound image localization position S extremely approaches the left-side speaker system 63, lying off the display 67.

Still further, the precedence effect also is caused, as is well known. The precedence effect is the following auditory physiological phenomenon: even if two sounds arriving at the same location have the same intensities, the sound arriving slightly earlier in time is perceived to be more intense. The sound from the left-side speaker unit 65 arrives at the listening position P earlier than the sound from the right-side speaker unit 66. As a result, the precedence effect is caused, and the sound from the left-side speaker unit 65 is perceived to be more intense, whereby the actual sound image localization position S tends to be deviated further leftward, even as compared with FIG. 20.

As described above, the listening position range is limited to the midmost in order to achieve the sound image localization at the center (hereinafter referred to as “center sound image localization”). Therefore, with the method in which no independent center speaker is installed, it is impossible for a plurality of persons to be involved at once in natural appreciation of movies. Likewise, in the stereo music reproduction also, it is impossible for a plurality of persons to be involved at once in music appreciation with excellent sound image localization.

In the case of the home theater movie reproduction, the above-described problem is solved by installing a center speaker, but in such a case, the center speaker has to be installed above or below the display, which causes upper or lower sound image localization positions of center channel audio signals to lie off the screen. Therefore, in the home theater movie reproduction employing a large display or screen in particular, the mismatch between sounds and video images becomes remarkable, which makes it impossible to allow natural appreciation of movies.

To solve the problem that the listening position range is limited to the midmost between the right and left speaker systems in order to achieve the center sound image localization, for example, a speaker device as shown in FIG. 21 is proposed in the Patent Document 1. In FIG. 21, in a left-side speaker system 71, two speaker units 71b and 71c are arranged horizontally in a cabinet 71a, while in a right-side speaker system 74, two speaker units 74b and 74c are arranged horizontally in a cabinet 74a.

The speaker units 71b and 71c are driven with frequencies in a range of 10 Hz to 2 kHz, for example, with a predetermined phase difference being provided from each other, and so are the speaker unit 74b and 74c. By so doing, the speaker systems 71 and 74 form dipole-like sound sources. This dipole-like sound source has frequency characteristics in that emission power attenuates in the mid-frequency range and below as shown in FIG. 22. Therefore, the frequency characteristic is corrected by a large-scale boosting on the low frequency side up to 200 Hz, as shown in FIG. 23.

With this configuration, for a listener PL on the left side shown in FIG. 21, for example, the sound pressure from the speaker system 71 immediately in front of the listener is minimized by the dipole emission characteristic of the speaker units 71b and 71c. On the other hand, since the sound pressure from the right-side speaker system 74 is at a considerable level, a sound image localization position is deviated toward the right-side speaker system 74 for the listener PL on the left side, whereby the center sound image localization can be achieved.

Further, as another proposal for solving the above-described problem, a configuration of a speaker device as shown in FIG. 24 is disclosed in the Patent Document 2. In FIG. 24, an acoustic lens 88 is attached to a front face of a left-side speaker system, while an acoustic lens 89 is attached to a front face of a right-side speaker system 86, in a manner such that the acoustic lenses 88 and 89 are symmetrical. Each of the acoustic lenses 88 and 89 has an inward-leaning directivity characteristic.

With this configuration, for example, when the listening position P is deviated rightward, the sound pressure from the left-side speaker system 83 is made higher as compared with the sound pressure from the right-side speaker system 86, due to the effect of the acoustic lens 88 on the left side. Thus, the listening position range where the center sound image localization can be achieved can be expanded.

Patent Document 1: JP 4(1992)-23399 U

Patent Document 2: JP 1(1989)-30399 A

### DISCLOSURE OF INVENTION

### Problem to be Solved by the Invention

However, the conventional speaker device disclosed by the Patent Document 1 needs large-scale boosting on the low frequency side so as to correct the emission power attenuation characteristic of the dipole-like sound source in the mid-range and below, and extremely large electric power is supplied to the speaker units 71b, 71c, 74b, and 74c, thereby damaging the speakers or distorting sounds. Thus, the foregoing speaker device has a problem that a high sound pressure level cannot be obtained.

Further, since the directivity of the speaker units 71b, 71c, 74b, and 74c becomes acute in the treble range, for example, the sound pressure level in the treble range reaching the listener PL on the left side from the right-side speaker system 74 falls significantly, and the effect of improving the sound image localization position falls drastically in the treble range. Thus, there is a problem that the effect of improving the sound image localization position cannot be achieved sufficiently.

Still further, sounds in a low frequency band emitted from a dipole-like sound source give a sense of significant discomfort. This is because a low frequency sound has an extremely long wavelength, and hence the sound emitted from each speaker unit reaches right and left ears of a human, with a phase difference being maintained completely. In other words, for example, for a listener PL on the left side, the sounds from the speaker unit 71c predominantly reach the left ear, while the sounds from the speaker unit 71b predominantly reach the right ear. Therefore, the right and left ears constantly hear sounds with phases reverse to each other, respectively, which causes the listener to feel a sense of significant discomfort.

Still further, the conventional speaker device disclosed by the Patent Document 2 has a problem that since the effects of the acoustic lenses 88 and 89 per se do not have significant magnitudes, the effect of improving the sound image localization position is small. The working principle of the acoustic lens is as follows: a fin of the acoustic lens extends a path length of sounds arriving from a peripheral portion of a diaphragm of a speaker unit to a listening position that lies off the axial front of the speaker unit, so as to adjust the path length to a path length of sounds arriving from a center portion of the diaphragm of the speaker unit; thereby phase interference and cancellation between sounds are prevented, and the directivity in a direction deviated from the axial front of the diaphragm is improved.

Accordingly, the acoustic lens is only capable of making the sound pressure level in a direction deviated from the axial front equal to the sound pressure on the axial front, but inherently is not capable of providing an effect of causing the level to exceed extensively the sound pressure on the axial front. Therefore, in FIG. 24, it is difficult to raise the sound pressure arriving from the speaker unit 83 to the listening position P so as to exceed the sound pressure arriving from the speaker unit 89 to the listening position P, which means that the effect of improving the sound image localization position is small.

Further, when the control of the directivity characteristic in a range up to the mid-range with use of an acoustic lens is intended, it is necessary to extend the traveling path length of a mid-range sound, which has a longer wavelength than that of a treble sound. Therefore, there is a problem that the acoustic lens is upsized, which causes the speaker system to be upsized.

An object of the present invention is to provide a speaker device that has an excellent effect in expanding a listening position range where the center sound image localization can be achieved with respect to voices such as singing voice and speech; that provides natural sound quality without causing sense of discomfort; that is capable of performing large sound pressure reproduction; and that can be downsized also.

### Means for Solving Problem

A speaker device of the present invention includces: a pair of speaker systems, each speaker system having a first speaker unit and a second speaker unit; and a signal adjustment part for adjusting a frequency characteristic of an input signal, the first speaker units being arranged symmetrically with respect to a listening center axis, and the second speaker units being arranged symmetrically with respect to the listening center axis, when the pair of speaker systems are arranged symmetrically with respect to the listening center axis. The first and second speaker units are arranged so that the first speaker unit emits a sound in an inward direction, and the second speaker unit emits a sound in a front direction of the speaker system or in an outward direction as compared with the direction of the first speaker unit, where the inward direction is defined as a direction in which the listening center axis is viewed from each speaker system. The signal adjustment part is configured so as to adjust the input signal so that the first speaker unit emits a sound at least in a mid-range and above; the second speaker unit emits a reproduction sound whose treble range is attenuated; and, with respect to a listening position in a front direction of one of the speaker systems, a sound arriving to the listening position from the first speaker unit of the speaker system located closer to the listening position, and a sound arriving to the listening position from the second speaker unit of the same speaker system, are destructive to each other in the mid-range owing to a phase difference between the sounds, whereby sound pressure in the mid-range arriving from the speaker system located closer to the listening position is attenuated more, as compared with a sound pressure in the mid-range arriving from the speaker system located farther from the listening position.

### EFFECTS OF THE INVENTION

With the speaker device of the foregoing configuration, a sound pressure arriving from the speaker system closer to the listening position can be decreased significantly in the entire band in the mid-range and above, as compared with a sound pressure arriving from the speaker system farther from the listening position, by utilizing the directivity of the first speaker unit with respect to the treble range, and by utilizing the phase difference between emitted sounds of the first and second speaker units and the arrangement position relationship with respect to the mid-range. Therefore, it is possible to achieve an excellent effect of expanding the listening position range in which the center sound image localization can be achieved.

Further, in the bass range, since the first speaker unit and the second speaker unit do not have to emit sounds having opposite phases to each other, natural sound quality that does not cause sense of discomfort can be obtained, while large sound pressure reproduction can be performed.

Still further, since there is no need to control the emission characteristic of the mid-range by a method dependent only on the directivity characteristic of the speaker unit itself, it is possible to downsize the speaker device.

### BRIEF DESCRIPTION OF DRAWINGS

FIG. 1 shows a configuration of a speaker device according to Embodiment 1 of the present invention.

FIG. 2 is a perspective view of the speaker device according to Embodiment 1 of the present invention.

FIG. 3 is a network circuit diagram of the speaker device according to Embodiment 1 of the present invention.

FIG. 4 is a frequency characteristic diagram of each speaker unit of the speaker device according to Embodiment 1 of the present invention.

FIG. 5 is a frequency characteristic diagram of the speaker device according to Embodiment 1 of the present invention.

FIG. 6 is an explanatory view showing the effect in the mid-range of the speaker device according to Embodiment 1 of the present invention.

FIG. 7 is an explanatory view showing the effect in the treble range of the speaker device according to Embodiment 1 of the present invention.

FIG. 8 is a speaker unit arrangement diagram of a speaker device according to another embodiment of the present invention.

FIG. 9 is a speaker unit arrangement diagram of a speaker device according to another embodiment of the present invention.

FIG. 10 is a speaker unit arrangement diagram of a speaker device according to another embodiment of the present invention.

FIG. 11 is a network circuit diagram of a speaker device according to Embodiment 2 of the present invention.

FIG. 12 is a frequency characteristic diagram of each speaker unit of the speaker device according to Embodiment 2 of the present invention.

FIG. 13 is a speaker unit arrangement diagram of a speaker device according to Embodiment 3 of the present invention.

FIG. 14 is a network circuit diagram of the speaker device according to Embodiment 3 of the present invention.

FIG. 15 is a frequency characteristic diagram of each speaker unit of the speaker device according to Embodiment 3 of the present invention.

FIG. 16 is a perspective view of a speaker device according to Embodiment 4 of the present invention.

FIG. 17 is a perspective view of a speaker device according to Embodiment 5 of the present invention.

FIG. 18 is a perspective view of a speaker device according to Embodiment 6 of the present invention.

FIG. 19 shows a configuration of a speaker device according to Embodiment 7 of the present invention.

FIG. 20 is an explanatory view showing a working of a conventional speaker device.

FIG. 21 shows a configuration of a conventional speaker device.

FIG. 22 is a frequency characteristic diagram of a conventional speaker device.

FIG. 23 is a frequency characteristic diagram of a conventional speaker device.

FIG. 24 shows a configuration of a conventional speaker device.

### DESCRIPTION OF REFERENCE NUMERALS

1 left-side speaker system

1a cabinet

2 first speaker unit

3 second speaker unit

4 right-side speaker system

4a cabinet

5 first speaker unit

6 second speaker unit

7 display

D distance in front-back direction

L2, L3, L5, L6 distance

P listening position

Pc center listening position

S center position

Vt synthetic sound pressure vector

V1, V2 sound pressure vector

W distance between speaker systems

X1-X2 listening center axis

### DESCRIPTION OF THE INVENTION

Based on the above-described configuration, the speaker device of the present invention may have the following various modifications.

That is, it is preferable that the mid-range is set to a frequency range including a part or an entirety of the second formant frequency and the third formant frequency of human voice. This makes it possible to achieve an excellent effect of expanding the listening position range in which the center sound image localization can be achieved with respect to voice such as singing voice and speech in particular.

Further, the configuration may be such that the first speaker unit is arranged on an inner side with respect to the second speaker unit as viewed from the listening center axis, and in the mid-range, a phase of an emitted sound of the first speaker unit is delayed as compared with a phase of an emitted sound of the second speaker unit. This makes it possible to achieve an excellent effect of expanding the listening position range in which the center sound image localization can be achieved, and to downsize the speaker system in the front-back direction.

Alternatively, the configuration may be such that the first speaker unit is arranged on an outer side with respect to the second speaker unit as viewed from the listening center axis, and in the mid-range, a phase of an emitted sound of the first speaker unit is advanced as compared with a phase of an emitted sound of the second speaker unit. This makes it possible to achieve an excellent effect of expanding the listening position range in which the center sound image localization can be achieved, and to dispose the speaker systems more backward, thereby increasing the degree of freedom in the arrangement.

Still further, a bass range of the first speaker unit may be attenuated, whereby the configuration of the network circuit of the speaker device can be simplified.

Still further, the first speaker unit and the second speaker unit may be arranged in a vertical relationship, whereby the speaker systems can be downsized in the width direction.

Still further, the first speaker unit may have a multiway configuration. This makes it possible to maintain an excellent effect of expanding the listening position range in which the center sound image localization can be achieved, and to enhance the sound quality itself.

Still further, the speaker systems function as a center speaker for multichannel reproduction, thereby having a configuration in which a front speaker system and the center speaker for multichannel reproduction are integrated. By so doing, a simple speaker device for multichannel reproduction can be obtained, which does not need the installation of an independent center speaker.

Still further, the configuration may be such that a center channel signal with treble range being attenuated, and a front channel signal, are supplied in a superimposed state to the second speaker unit. Since this configuration allows the number of speaker units to be minimized, a low-cost and small-size speaker device for multichannel reproduction can be obtained.

The following describes embodiments of the present invention in detail, while referring to the drawings.

### EMBODIMENT 1

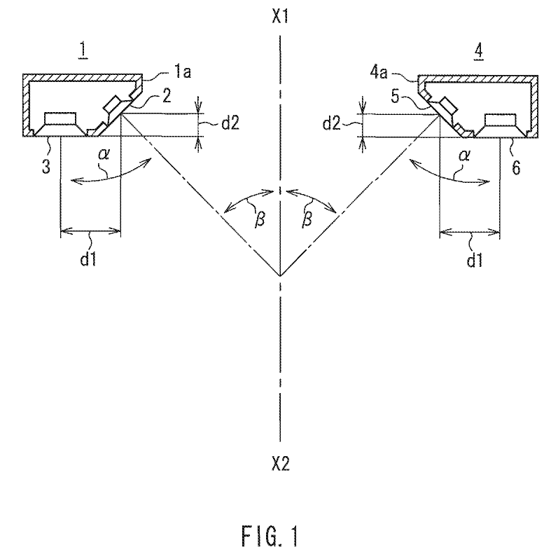

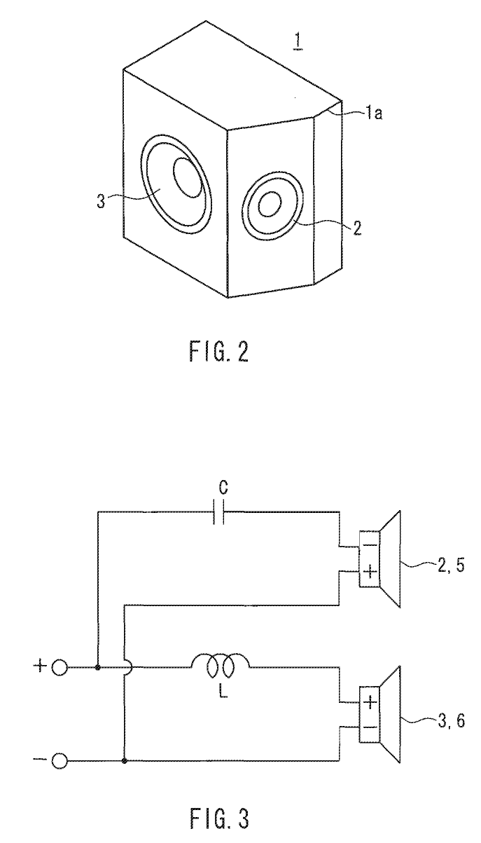

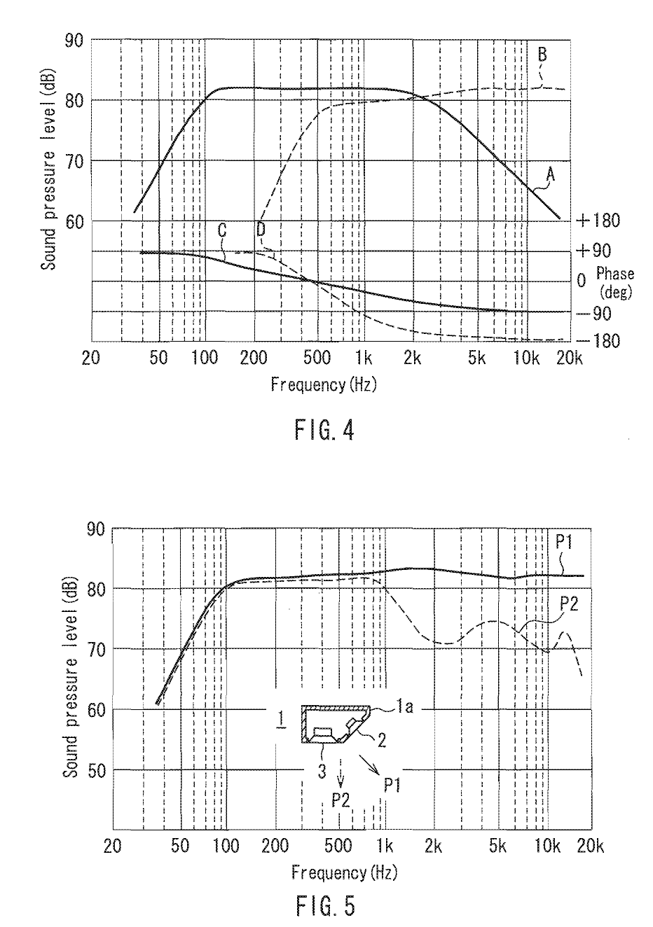

First of all, a configuration of a speaker device according to Embodiment 1 of the present invention is described below, with reference to FIGS. 1 to 4. FIG. 1 shows a configuration of a speaker device according to Embodiment 1 of the present invention. FIG. 2 is a perspective view of the forgoing speaker device. FIG. 3 is a network circuit diagram of the foregoing speaker device. FIG. 4 is a frequency characteristic diagram of each speaker unit of the foregoing speaker device.

In FIG. 1, the left-side speaker system 1 and the right-side speaker system 4 are placed on both sides of a listening center axis X1-X2, at substantially the same distances from the listening center axis X1-X2. In a cabinet 1a of the left-side speaker system 1, there are installed a first speaker unit 2 and a second speaker unit 3. In a cabinet 4a of the right-side speaker system 4, there are installed a first speaker unit 5 and a second speaker unit 6. The arrangement of the speaker units 2, 3, 5, and 6 is symmetrical with respect to the listening center axis X1-X2.

Each of the first speaker units 2 and 5 is, for example, a 6.5-cm-diameter full-range unit, and is sealed on the back so that its diaphragm is not vibrated by the air pressure of a bass sound in the cabinet. Each of the second speaker units 3 and 6 is a 8-cm-diameter bass-range unit, for example.

Defining each direction viewed from each of the speaker systems 1 and 4 to the listening center axis X1-X2 to be an inward direction, the first speaker units 2 and 5 are positioned on inner sides with respect to the second speaker units 3 and 6, respectively, and are arranged so as to emit sounds in the inward direction. The second speaker units 3 and 6 are arranged so as to emit sounds in a front direction, and hence, they emit sounds in directions outward with respect to the directions of the first speaker units 2 and 5, respectively.

Angles β of the sound emission direction of each of the first speaker units 2 and 5 with respect to the listening center axis X1-X2 are approximately 45°. Therefore, each angle α between the sound emission directions of the second speaker units 3 and 6 and the sound emission directions of the first speaker units 2 and 5, respectively, is approximately 45°. A distance pitch d1 in the horizontal direction between the first speaker units 2 and 5 and the second speaker units 3 and 6, respectively, is approximately 9 cm, and a distance pitch d2 in the depth direction therebetween is approximately 4 cm. The first speaker units 2 and 5 and the second speaker units 3 and 6 are arranged horizontally as shown in the perspective view of FIG. 2.

Signals to drive this speaker device are supplied via a 6-dB/oct-type network circuit composed of a low-range cut-off capacitor C and a high-range cut-off coil L as shown in FIG. 3 schematically, so that frequency characteristics are adjusted. By so doing, signals whose low range is attenuated are fed to the first speaker units 2 and 5, while signals whose high range is attenuated are fed to the second speaker units 3 and 6. Besides, the first speaker units 2 and 5 and the second speaker units 3 and 6 are connected to a network circuit, with polarities reverse to each other, respectively. In FIG. 3, input signals are supplied to input terminals (+) and (−), after being amplified by an amplifier circuit (not shown) in a previous stage.

Frequency characteristics of the speaker units 2, 3, 5, and 6 at the same measurement distances on the axes are as shown in FIG. 4. A sound pressure frequency characteristic of the first speaker units 2 and 5 are indicated with a broken line B, and a phase frequency characteristic thereof is indicated with a broken line D. A sound pressure frequency characteristic of the second speaker units 3 and 6 is indicated with a solid line A, and a phase frequency characteristic thereof is indicated with a solid line C.

The frequency characteristics in FIG. 4 show a synergistic effect of characteristics of the speaker units 2, 3, 5, and 6, and division characteristic of the network circuit. As a result, the first speaker units 2 and 5 have a reproduction frequency band of not lower than about 500 Hz (−6 dB), as indicated by the broken line B. The second speaker units 3 and 6 have a reproduction frequency band ranging from a bass range to about 4 kHz (4 dB), as indicated by the solid line A. Therefore, mid-range sounds of about 500 Hz to 4 kHz are reproduced by both of the first speaker units 2 and 5 and the second speaker units 3 and 6.

It should be noted that as clear from the characteristics indicated by A and B in FIG. 4, in the mid-range, the sound pressure level of the first speaker units 2 and 5 is set slightly lower than that of the second speaker units 3 and 6. This is intended to adjust the effect of the center sound image localization, as described below.

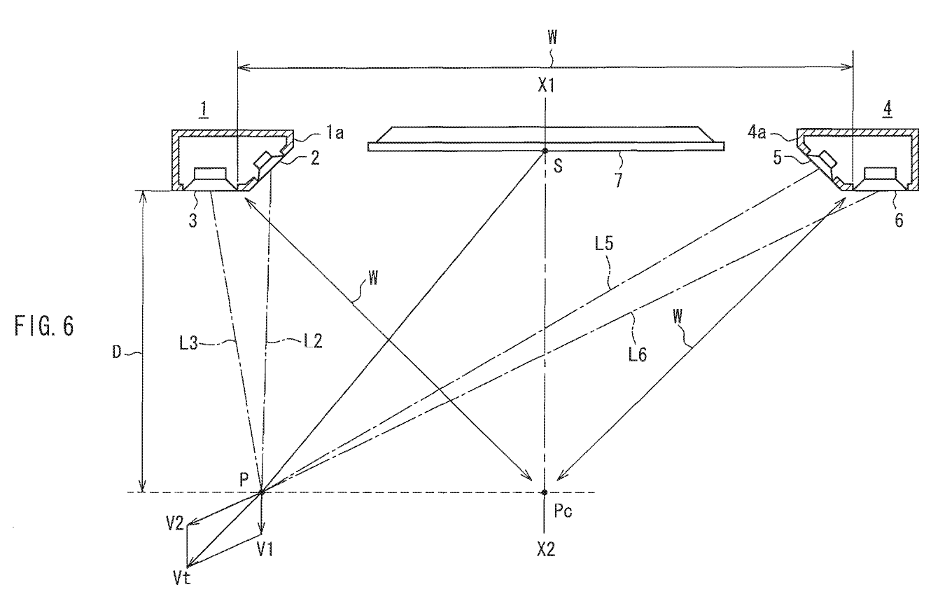

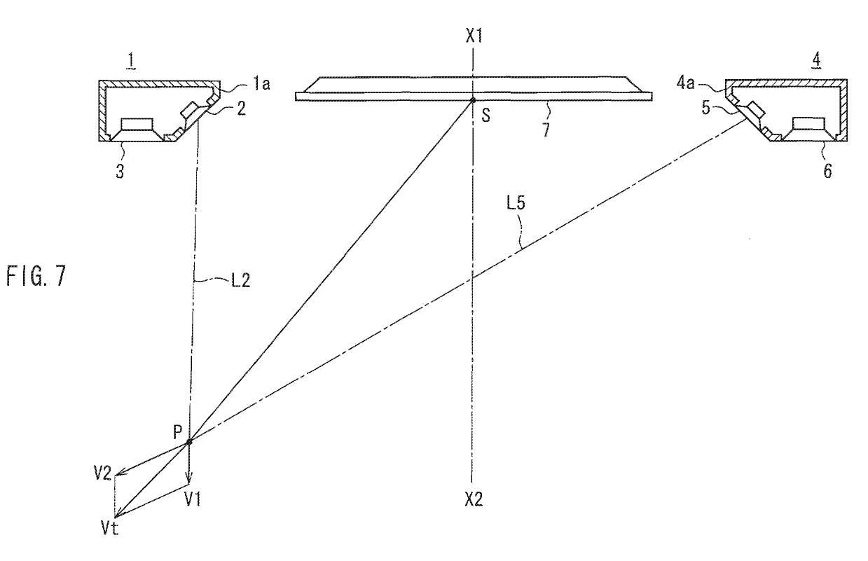

The following describes the action and effect of the speaker device according to Embodiment 1, which is configured as described above, while referring to FIGS. 5 to 7. FIG. 5 is a frequency characteristic diagram of the speaker device according to the present embodiment, FIG. 6 is an explanatory view showing the effect of the foregoing speaker device in the mid-range, and FIG. 7 is an explanatory view showing the effect of the foregoing speaker device in the treble range.

In FIG. 5, a solid line P1 represents a sound pressure frequency characteristic of the speaker system 1 in the front direction of the first speaker unit 2 (5). A broken line P2 represents sound pressure frequency characteristic of the speaker system 1 in the front direction of the second speaker unit 3 (6), in other words, in the front direction of the speaker system 1. The following characteristics are obtained: a high sound pressure level is obtained in the front direction of the first speaker unit 2 (P1), while the sound pressure level significantly attenuates in the mid-range band and above in the front direction of the speaker system 1 (P2).

The principle and effect for the obtainment of such characteristics are described in detail. As represented by the solid line C in FIG. 4, with regard to the second speaker units 3 and 6, an emitted sound in a mid-range of several hundreds Hz, which is a middle range of a reproduction band, has a phase of about 0°. This phase is delayed by about 90° toward the treble range by a 6-dB/oct-type low-pass filter (high-cut) network circuit. It should be noted that the reason why the phase advances in the bass range is that attenuation occurs in the low frequency range.

With regard to the first speaker units 2 and 5, since they are connected in reverse phase as shown in FIG. 3, a phase frequency characteristic thereof delays by 180° in the treble range as represented by the dotted line D in FIG. 4. Assuming that the first speaker units 2 and 5 are connected in normal phase, as is the case with the second speaker units 3 and 6, the phase thereof would be 0° in the treble range. Then, the phase advances by about 90° toward the bass range side by the 6-dB/oct-type high-pass filter (low-cut) network circuit, and the phase further advances due to the attenuation in the bass range of the speaker units 2 and 5 themselves. In other words, in a range from the mid-range to the treble range, the phase of the emitted sound of the first speaker units 2 and 5 has a delay of about 90° as compared with the phase of the emitted sound of the second speaker units 3 and 6.

As a result, the sound pressure frequency characteristic in the vicinity of the front direction of the first speaker units 2 and 5 is such a characteristic, obtained by adding respective sound pressures of the first speaker unit 2 (5) and the second speaker unit 3 (6) as represented by the solid line Pl shown in FIG. 5. On the other hand, the sound pressure frequency characteristic in the vicinity of the front direction of the second speaker unit 3 (6) is such a characteristic having level attenuation in a range from the mid-range to the treble range as represented by the dotted line P2 in FIG. 5.

The principle and effect thereof are described with reference to FIG. 6. In FIG. 6, a display 7 is installed at the midpoint between the left-side speaker system 1 and the right-side speaker system 4, and a center position of the display 7 is denoted as S. An ideal center listening position Pc lies on the listening center axis X1-X2. Assume that an actual listening position P lies approximately in the front direction of the speaker system 1 closer thereto. Each speaker system 1, 4 is similar to that shown in FIG. 1.

The position relationship between the center listening position Pc and the speaker systems 1 and 4 is in a standard arrangement in which they are positioned in the vicinities of vertexes of an approximate regular triangle, respectively. Therefore, a depth-direction distance D from the speaker systems 1 and 4 to the listening positions Pc and P is under the positional relationship satisfy D=0.87 W. “W” represents a distance between the speaker systems 1 and 4. This standard arrangement is recommended not only for the conventional 2-channel stereo reproduction, but also for multichannel speaker systems in the ITU-R Recommendations.

In the present embodiment, the first speaker units 2 and 5 are arranged at inner positions as compared with the second speaker units 3 and 6, respectively, as shown in FIG. 6. Therefore, a distance L5 from the first speaker unit 5 of the speaker system 4, which is farther from the listening position P, to the listening position P is shorter than a distance L6 from the second speaker unit 6 to the listening position P. For example, in the above-described standard speaker system arrangement relationship and the configuration dimensions of the speaker device of the present embodiment, the distance L5 is about 4 cm shorter than the distance L6.

Since the phase of the emitted sound of the first speaker unit 5 delays by about 90° in the mid-range originally (immediately after the emission from the speaker unit) as compared with the phase of the emitted sound of the second speaker unit 6, the phase difference at the listening point P between the respective arriving sounds from the foregoing units is caused to decrease due to L5 being shorter than L6. As a result, the phase difference between the arriving sound from the first speaker unit 5 and the arriving sound from the second speaker unit 6 approaches 0°, whereby both the emitted sounds are constructive each other.

On the other hand, in the speaker system 1 closer to the listening position P, the distance L2 from the first speaker unit 2 to the listening position P is greater than the distance L3 from the second speaker unit 3 to the listening position P. For example, in the above-described standard speaker system arrangement relationship and the dimensions of the speaker unit arrangement relationship of the speaker device of the present embodiment, the distance L2 is about 4 cm longer than the distance L3.

Since the phase of the emitted sound of the first speaker unit 2 delays by about 90° in the mid-range originally as compared with the phase of the emitted sound of the second speaker unit 3, the phase difference at the listening point P between the respective arriving sounds from the foregoing units is caused to increase due to L3 being shorter than L2. As a result, the phase difference between the arriving sound from the first speaker unit 5 and the arriving sound from the second speaker unit 6 approaches 180°, whereby both the emitted sounds are destructive to each other.

The above effect is maximized at the frequency with which a sound wave has a phase rotation of 90° due to the distance difference between L5 and L6 or the distance difference between L2 and L3, that is, at the frequency with which the distance difference becomes equal to ¼ the wavelength of the sound. In the present embodiment, the distance difference between L5 and L6 and the distance difference between L2 and L3 are 4 cm each. Therefore, the above-described effect is maximized in the vicinity of 2 kHz at which 4 cm is equivalent to ¼ wavelength. As the frequency decreases from the vicinity of 2 kHz, this effect gradually decreases. This applies to the speaker system 1 closer to the listening position P similarly.

As the frequency increases from the vicinity of 2 kHz, the foregoing effect gradually declines. For example, in the vicinity of 4 kHz at which the distance difference of 4 cm is equivalent to ½ wavelength, the sound wave has a phase advance of 180° due to the distance difference, whereby the phase of the arriving sound from the first speaker unit 5 to the listening position P advances by 90° with respect to the phase of the arriving sound from the second speaker unit 6 to the listening position P. In other words, in the vicinity of 4 kHz, the arriving sound from the first speaker unit 5 and the arriving sound from the second speaker unit 6 are not constructive to each other, and hence, the above-described effect is minimized.

This also occurs to the speaker system 1 closer to the listening position P. In other words, in the vicinity of 4 kHz, a sound wave has a phase delay of 180° due to a distance difference, and this results in that the phase of the arriving sound from the first speaker unit 2 to the listening position P delays by 270° as compared with the phase of the arriving sound from the second speaker unit 3 to the listening position P. In other words, in the vicinity of 4 kHz, the arriving sound from the first speaker unit 2 and the arriving sound from the second speaker unit 3 are not destructive to each other, and consequently, the above-described effect is minimized.

Further, in the case of a higher frequency, for example 6 kHz, in the vicinity of 6 kHz at which a distance difference of 4 cm is equivalent to ¾ wavelength, a sound wave has a phase advance of 270° due to the foregoing distance difference, and hence, the phase of the arriving sound from the first speaker unit 5 to the listening position P advances by 180° as compared with the phase of the arriving sound from the second speaker unit 6 to the listening position P. In other words, considering the phase of the sound alone, in the vicinity of 6 kHz, the emitted sound of the first speaker unit 5 and the emitted sound of the second speaker unit 6 cancel each other; this is the inverse of the intended effect.

This applies to the speaker system 1 closer to the listening position P. More specifically, in the vicinity of 6 kHz at which a distance difference of 4 cm is equivalent to ¾ wavelength, a sound wave has a phase delay of 270° due to the foregoing distance difference, and hence, the phase of the arriving sound from the first speaker unit 2 to the listening position P delays by 360° as compared with the phase of the arriving sound from the second speaker unit 3 to the listening position P. In other words, considering the phase of the sound alone, in the vicinity of 6 kHz, the emitted sound of the first speaker unit 2 and the emitted sound of the second speaker unit 3 are constructive to each other; this is the inverse of the intended effect.

Therefore, in the speaker device according to the present embodiment, as represented by the solid line A of FIG. 4, the treble range of the second speaker units 3 and 6 are attenuated. This is because the constructive and destructive effects from the superimposition of two sound waves are maximized when the two sound waves have similar sound pressures, and significantly decrease as a sound pressure difference between the two sound waves increases. Therefore, by attenuating the treble range of the second speaker units 3 and 6, the inverse effect can be prevented from occurring in the treble range in which a phase rotation of a sound wave due to a distance difference becomes excessive.

In the mid-range, with the above-described principle and effect, as shown in FIG. 6, a sound pressure vector V1 of the speaker system 1 closer to the listening position P can be decreased significantly as compared with a sound pressure vector V2 of the speaker system 4 farther from the listening position P. As a result, a sound image in the mid-range can be localized in the vicinity of the center position S of the display 7.

Based on the above-described principle and effect, a geometrical analysis was made regarding appropriate conditions for causing a sound image to be localized in the vicinity of the center, in the case of the listening position P shown in FIG. 6, that is, in the case where the listening position P is positioned in the vicinity of the front direction of the speaker system 1 closer to the listening position P. As a result, though the description of a detailed calculation process is omitted herein, it was found that in the case of the standard arrangement in which the center listening position Pc and the respective speaker systems 1 and 4 are positioned in the vicinities of vertexes of an approximate regular triangle, sound image localization in the vicinity of the center can be obtained at the listening position P by setting the level difference between the sound pressure vector V1 of the speaker system 1 and the sound pressure vector V2 of the speaker system 2 to about 7.5 dB.

Besides, an analysis was made also regarding the case where the center listening position Pc and the respective speaker systems 1 and 4 are positioned in the vicinities of vertexes of a rectangular equilateral triangle, that is, the case where a front-back direction distance D from the speaker systems 1 and 4 to the listening positions Pc and P satisfies the position relationship of D=0.5 W. It was found that in this case, sound image localization in the vicinity of the center can be obtained by setting the level difference between the sound pressure vector V1 of the speaker system 1 and the sound pressure vector V2 of the speaker system 2 to about 14 dB.

Thus, it was found that in order to obtain sound image localization in the vicinity of the center at the listening position P shown in FIG. 6, generally a sound pressure level difference of about 10 dB is required. In the present embodiment, as shown in FIG. 5, there is a sound pressure difference of about 10 dB in the mid-range, and hence, an excellent effect of the center sound image localization can be achieved.

Next, an effect of the speaker device according to the present embodiment in the treble range is described with reference to FIG. 7. Since the sound pressure of the second speaker units 3 and 6 attenuates in the treble range as represented by the solid line A in FIG. 4, the effect in the treble range depends on the first speaker units 2 and 5.

In FIG. 7, the direction of sound emission from the first speaker unit 5 farther from the listening position P is in the vicinity of the front direction of the listening position P. On the other hand, the direction of sound emission of the first speaker unit 2 closer to the listening position P is tilted significantly with respect to the listening position P. Therefore, sounds from the first speaker unit 5 farther from the listening position P are not caused to have the treble-range attenuation due to the directivity characteristic of the first speaker unit 5. On the other hand, sounds from the first speaker unit 2 closer to the listening position P are not caused to have the treble-range attenuation due to the directivity characteristic of the first speaker unit 2.

As a result, the sound pressure vector V1 in the treble range of the first speaker unit 2 closer to the listening position P can be decreased significantly, as compared with the sound pressure vector V2 in the treble range of the first speaker unit 5 farther from the listening position P. Consequently, a sound image in the treble range can be localized in the vicinity of the center position S of the display 7.

According to acoustics, the following has been known: assuming that an effective vibrating radius and a wavelength constant of a speaker unit are a and k, respectively, there is no directivity at a frequency of about ka=1 or below, the directivity starts narrowing at a frequency of about ka=2 or above, and the directivity significantly narrows at a frequency of about ka=3 or above. In the speaker device according to the present embodiment, each of the first speaker units 2 and 5 has a diameter of about 6.5 cm, for example, and an effective vibrating radius thereof is about 26 mm. Therefore, the directivity starts narrowing in the vicinity of 4 kHz at which ka=2, and significantly narrows in the vicinity of 6 kHz or above at which ka=3.

Thus, according to the present embodiment, in a frequency band above 4 kHz at which the above-described effect based on the phase difference of emitted sounds and the position relationship of the first speaker units 2 and 5 and the second speaker units 3 and 6 becomes smaller, the effect based on the directivity of the first speaker units 2 and 5 is utilized. As a result, an effect of sufficiently decreasing the sound pressure vector Vi of the speaker system 1 closer to the listening position P as compared with the sound pressure vector V2 of the speaker system 4 farther from the listening position P can be obtained through the entire frequency band in the mid-range and above.

So far, the action and effect in the case where the listening position P is located in the vicinity of the front direction of the speaker system 1 closer to the listening position P are described with reference to FIGS. 6 and 7. On the other hand, an analysis and experiments were carried out regarding the case where the listening position P was closer to the center listening position Pc, and the contrary case where the listening position P was moved further outward from the vicinity of the front of the speaker system 1.

As the listening position P approaches the center listening position Pc, an attenuated sound pressure level of the sound pressure vector V1 of the speaker system 1 closer to the listening position P may be required to have a smaller difference from a sound pressure level of the sound pressure vector V2 of the speaker system 4 farther from the listening position P. For example, it was found as a result of calculation that when the listening position P is located at the midpoint between the position thereof shown in FIG. 6 and the center listening position Pc, the sound pressure level difference may be about 4 dB in order to achieve a sufficient effect.

In other words, since the sound pressure level difference required when the listening position P is located in the vicinity of the front direction of the speaker system 1 closer to the listening position P is about 7.5 dB as described above, only about half the same is sufficient.

As the listening position P approaches the center listening position Pc, the difference between the distance to the listening position P from the first speaker units 2 and 5 and the distance thereto from the second speaker units 3 and 6 decreases roughly proportionally. Therefore, in the mid-range, the phase rotation amount of a sound wave owing to the distance difference decreases roughly proportionally, and the interference effect between arriving sounds owing to the phase rotation also decreases, whereas a sound pressure level difference required for localizing a sound image in the vicinity of the center also decreases roughly proportionally.

In the treble range also, as the listening position P approaches the center listening position Pc, the tilt of the sound emission direction of the second speaker unit 2 closer to the listening position P decreases roughly proportionally, and a sound pressure level difference caused by the tilt of the sound emission direction decreases, whereas a sound pressure level difference required for localizing a sound image in the vicinity of the center also decreases roughly proportionally.

Therefore, by employing a configuration such that an excellent effect of the center sound image localization can be obtained in the case where the listening position P is located in the vicinity of the front direction of the speaker system 1 closer to the listening position P, in other words, by ensuring the required sound pressure level difference at the foregoing listening position, an excellent effect of the center sound image localization can be obtained, wherever the listening position P is located between the speaker systems 1 and 4. In other words, the listening position range where the center sound image localization can be achieved can be expanded to the full distance between the speaker systems 1 and 4.

To the contrary, if the effect of the center sound image localization is insufficient in the case where the listening position P is located in the vicinity of the front direction of the speaker system 1 closer to the listening position P, in other words, if the above-described required sound pressure level difference cannot be ensured at the foregoing listening position, the effect of the center sound image localization is impaired, wherever the listening position P is located between the speaker systems 1 and 4.

It should be noted that, in fact, as long as the deviation of the sound image localization position from the center is insignificant, a practically sufficient effect of the center sound image localization can be achieved. For example, in a case such as movie appreciation where the listening and the viewing of a screen are performed at the same time, sound images tend to be localized approximately at the center easily. Therefore, even if the above-described sound pressure level difference when the listening position P is located in the vicinity of the front direction of the speaker system 1 closer to the listening position P is smaller than that in an ideal state, a practically sufficient effect can be achieved, though the listening position range in which the center sound image localization can be achieved is narrowed.

Next, the following describes results of analytical calculation regarding the case where the listening position P moves outward from the vicinity of the front of the speaker system 1. For example, when the listening position P moved to the left side by about W×½ from the position in the front direction of the speaker system 1 closer to the listening position P, the above-described required sound pressure level difference was found to be about 9.5 dB.

Besides, analytical calculation was made in the same manner regarding the case where the center listening position Pc and the respective speaker systems 1 and 4 are positioned in the vicinities of vertexes of a rectangular equilateral triangle, that is, the case where a depth direction distance D from the speaker system 1 and 4 to the listening positions Pc and P satisfies the position relationship of D=0.5 W. In this case, when the listening position P moved outward to the left side by about W×½ from the position in the front direction of the speaker system 1 closer to the listening position P, the above-described required sound pressure level difference was found to be about 14 dB.

In other words, it was found that the above-described required sound pressure level difference when the listening position P moved outward from the vicinity of the front of the speaker system 1 did not have much difference from the above-described required sound pressure level difference when the listening position P was located in the vicinity of the front direction of the speaker system 1.

Therefore, by setting the above-described sound pressure level difference to the required level when the listening position P is located in the vicinity of the front direction of the speaker system 1 or to a level slightly greater than that, the listening position range in which the center sound image localization can be achieved can be expanded beyond the range extending between the speaker systems 1 and 4.

It should be noted that since the precedence effect works in actuality, better results can be obtained if the sound pressure level difference is set slightly greater than the above-described value. Conversely, if the above-described sound pressure level difference is excessively great, in some cases a sound image is localized at a position deviated, over the vicinity of the center, toward the speaker system farther from the listening position. In such a case, a small level difference may be provided between the sound pressure level of the first speaker unit 2 and 5 and the sound pressure level of the second speaker units 3 and 6 in the mid-range.

Next, a frequency range in which the above-described sound pressure level difference is provided is described below in detail. The speaker device of the present embodiment is configured so that, as shown in FIG. 5, in the frequency band of about 1 kHz and above, the sound pressure vector V1 of the speaker system 1 closer to the listening position P is significantly smaller than the sound pressure vector V2 of the speaker system 4 farther from the listening position P. With this configuration, an improved effect can be achieved for expanding the listening position range in which the center sound image localization is achieved with respect to voices such as singing voice and speech in particular. A reason for this is described below.

Basic frequencies of human voices are about 80 Hz to 400 Hz for male voices, and about 150 Hz to 900 Hz for female and child voices, which are rather close to. the bass range. It is known, however, that apart from these, there are peculiar frequency spectra called “formants”, which characterize human voices, and that the formants of vowels are important particularly.

The formants are called “first formant”, “second formant”, and “third formant” in the frequency ascending order. Irrespective of the language, for the male, female, and child voices in general, the range of the first formant frequency is about 300 Hz to 1 kHz. The range of the second formant frequency is about 800 Hz to 3 kHz, and the range of the third formant frequency is about 2.5 kHz to 4 kHz.

Experiments were carried out to find which frequency band, among the basic frequency of voice, the first formant frequency, the second formant frequency, and the third formant frequency, has the most significant influence on the effect of the center sound image localization. More specifically, a controlling operation of significantly attenuating a sound pressure arriving from the speaker system 1 closer to the listening position P as compared with a sound pressure arriving to the listening position P from the speaker system 4 farther from the listening position P was performed with respect to each of the foregoing frequency ranges, and the effect was checked.

As a result, only a very small effect was obtained in the case where the foregoing controlling operation was carried out with respect to the frequency band of 150 Hz to 900 Hz alone, which is the basic frequency of voice. A great effect was obtained by controlling the frequency range of the second formant, which was followed by an effect with respect to the third formant frequency, and an effect with respect to the first formant frequency. Also it was found that an extremely excellent effect was obtained by controlling both the second formant frequency and the third formant frequency. It can be considered that conducive to this would be the fact that the frequency range of the second and third formants is the frequency band to which the human ears have high sensitivity.

It should be noted that even when the frequency range subjected to the foregoing controlling operation did not cover the overall range of the second formant frequency and the third formant frequency, in other words, even when a part of the frequency band of 800 Hz to 4 kHz was subjected to the foregoing operation, a practical effect was obtained also. Among the foregoing part of the frequency band, the frequency band in the vicinity of 2 kHz to 4 kHz was particularly effective. Also it was found that a sufficient effect was obtained by controlling the above-described mid-range, without specifically controlling the frequency band of 150 Hz to 900 Hz, which is the basic frequency of voice. Therefore, it was clarified that with regard to a low frequency band, which, when arriving to a human ear together with opposite phases at the same time, causes a sense of discomfort, there is no need to shift the phase of an emitted sound from each of the first speaker units 2 and 5 and the phase of an emitted sound from each of the second speaker units 3 and 6.

On the other hand, since voiced consonants contain much of high frequency components, by performing the foregoing controlling operation also in the treble range, an excellent effect of the center sound image localization can be achieved with respect to both vowels and consonants. Therefore, it was clarified that an excellent effect for expanding a listening position range in which the center sound image localization can be achieved with respect to a voice such as singing voice and speech in particular by performing the above-described controlling operation with respect to the mid-range and the treble range including a part or an entirety of the second formant frequency and the third formant frequency of the human voice.

Experiments were carried out by using the speaker device of the present embodiment configured as described above as a center speaker of multichannel reproduction equipment. More specifically, the same center channel output signal was fed to both of speaker systems in pair, arranged on both sides of a display. As a result, the following effect was obtained sufficiently: wherever the position for watching a movie was located, even if, for example, the position was significantly deviated from the center of the display or located outside the speaker on either side, speech and singing voice always were heard from the vicinity of the display.

Besides, in the speaker device of the present embodiment, since the first speaker units 2 and 5 were arranged on the inner sides with respect to the second speaker units 3 and 6, respectively, as viewed from the listening center axis X1-X2, the speaker systems 1 and 4 could be downsized in the front-back direction. It is possible to arrange the speaker units in another manner, but this will be described later.

In the speaker device of the present embodiment, by attenuating the bass range of the first speaker units 2 and 5, the network circuit can be allowed to have an extremely simple configuration as shown in FIG. 3. The network circuit may have another configuration, which will be described later.

As described above, the speaker device of the present embodiment is formed with at least a pair of speaker systems 1 and 4 that are approximately symmetrically arranged on both sides to the listening center axis X1-X2 with distances therebetween. The speaker systems 1 and 4 include the first speaker units 2 and 5 and the second speaker units 3 and 6, respectively. The speaker units 2, 3, 5, 6 are arranged approximately symmetrically as viewed from the listening center axis X1-X2. Assuming that the directions in which the listening center axis X1-X2 is viewed from the speaker systems 1 and 4 are inward directions, the first speaker units 2 and 5 emit sounds in the inward directions, while reproducing at least the mid-range and above; and the second speaker units 3 and 6 emit sounds in the vicinity of the front directions of the speaker systems 1 and 4, respectively, or in outward directions with respect to the directions of the first speaker units 2 and 5, respectively, while attenuating the treble range. The configuration is made such that, for a listening position in the vicinity of the front direction of one of the speaker units 1 and 4, a sound arriving from the first speaker unit of one of the speaker systems closer to the listening position, and a sound arriving from the second speaker unit of the same speaker system, are destructive to each other in the mid-range. This causes a sound pressure in the mid-range arriving from the speaker system closer to the listening position to be attenuated as compared with a sound pressure in the mid-range arriving from the speaker system farther from the listening position.

This configuration makes it possible that, in an entire band of the mid-range and higher, the sound pressure arriving from the speaker system closer to the listening position to significantly decrease as compared with the sound pressure arriving from the speaker system farther from the listening position, whereby an excellent effect of expanding the listening position range in which the center sound image localization can be achieved. In the bass range, since the first speaker unit and the second speaker unit do not emit sounds having phases opposite to each other, natural sound quality that does not cause sense of discomfort can be obtained, while large sound pressure reproduction can be performed. Further, since there is no need to control the emission characteristic of the mid-range by a method depending only on the directivity characteristic of the speaker unit itself, the speaker device can be downsized.

Preferably, the mid-range is set to the frequency range including a part or an entirety of the second formant frequency and the third formant frequency of human voice. By so doing, it is possible to achieve an excellent effect of expanding the listening position range in which the center sound image localization can be achieved with respect to a voice such as singing voice and speech in particular.

Further, the configuration can be made such that the first speaker units 2 and 5 are arranged on inner sides with respect to the second speaker units 3 and 6, respectively, as viewed from the listening center axis X1-X2, and in the mid-range, the phases of the emitted sounds of the first speaker units 2 and 5 are delayed as compared with the phases of the emitted sounds of the second speaker units 3 and 6, respectively. By so doing, it is possible to achieve an excellent effect of expanding the listening position range in which the center sound image localization, and to downsize the speaker system in the front-back direction.

Still further, the configuration can be made such that the bass range of the first speaker units 2 and 5 can be attenuated.

It should be noted that in the present embodiment each angle β between the sound emission directions of the first speaker units 2 and 5 and the listening center axis X1-X2 is set at about 45°, but it is possible to achieve the effect of the present invention by setting the angle β at 15° to 90°.

By setting the angle β greater, the dimensions of the speaker systems 1 and 4 in the width direction can be reduced. However, in this case, the treble range tends to become insufficient due to the directivity of the first speaker units 2 and 5. Therefore, the treble range may be boosted by an amplifier or the like.

By setting the angle β smaller, the dimensions of the speaker systems 1 and 4 in the front-back direction can be reduced. However, in this case, the listening position at which the effect of the present invention can be achieved is distant from the speaker systems 1 and 4 in the front-back direction. Therefore, the angle β may be determined with the required dimensions of the speaker system and the desired listening position range taken into consideration.

Further, in the present embodiment, the sound emission directions of the second speaker units 3 and 6 are set in the front direction. However, the only requirement is that the second speaker units 3 and 6 emit sounds in outward directions as compared with the first speaker units 2 and 5, respectively, and they do not necessarily have to face in the exact front direction. In other words, herein the front direction includes a direction slightly deviated with respect to the exact front direction, as long as such a deviation is in a range such that the effect of the invention can be achieved. Still further, in the present embodiment, an angle α between the sound emission directions of the second speaker units 3 and 6 and the sound emission directions of the first speaker units 2 and 5, respectively, is set at about 45°, but it is possible to achieve the effect of the present invention by setting this angle α at 15° to 90°.

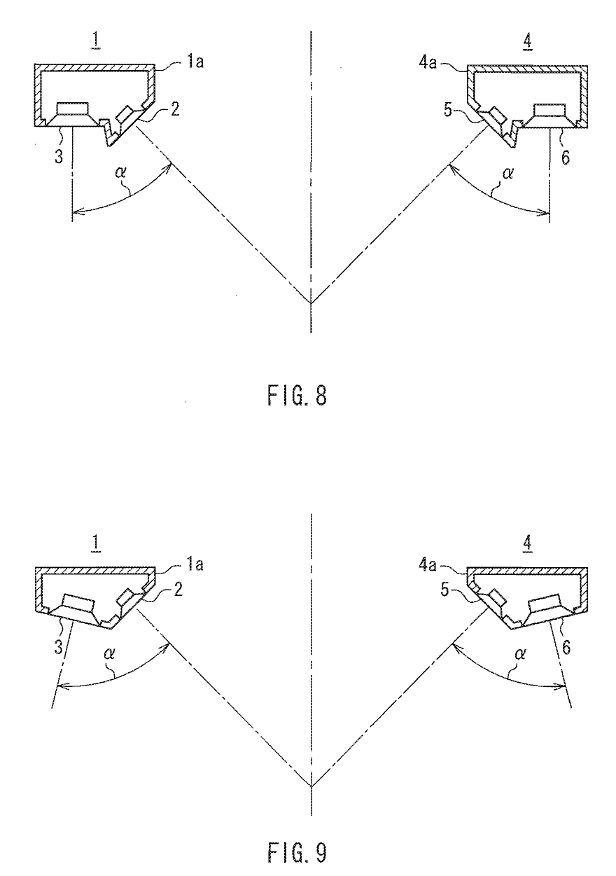

Exemplary possible arrangements of the first speaker units 2 and 5 and the second speaker units 3 and 6 are shown in FIGS. 8 to 10.

In the arrangement shown in FIG. 8, the positions of the first speaker units 2 and 5 and the positions of the second speaker units 3 and 6 in the front-back direction are adjusted to coincide with each other. With this arrangement, the dimension of the speaker systems 1 and 4 in the front-back direction can be reduced. Besides, since the emitted sound of the second speaker unit becomes less obstructed by the display, the speaker systems 1 and 4 can be disposed more backward, whereby the degree of freedom in the arrangement is increased.

However, in the case where this arrangement is selected, a distance of arrival from the first speaker unit 2 and a distance of arrival from the second speaker unit 3 to the listening position in the vicinity of the front direction of one speaker system 1 become equal. Therefore, by delaying the phases of emitted sounds of the first speaker units 2 and 5 by about 180° with respect to the phases of emitted sounds of the second speaker units 3 and 6, respectively, in the mid-range, the same effect of the present invention as described above can be achieved. This may be implemented by a network circuit, or alternatively, by phase control by an amplifier connected with each speaker unit.

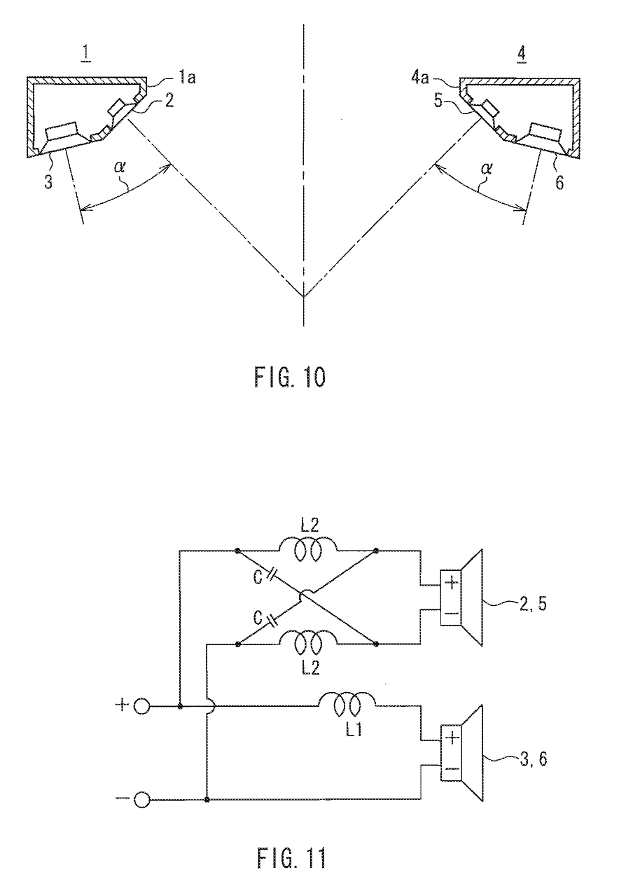

In the arrangement shown in FIG. 9, the sound emission directions of the second speaker units 3 and 6 are directed slightly outward. In the arrangement shown in FIG. 10, the sound emission direction of the second speaker units 3 and 6 are directed slightly inward. Apart from these, a speaker unit arrangement as in Embodiment 3 that will be described later is practicable. Thus, various arrangements are practicable.

In the present embodiment, the phase of the emitted sound of the first speaker unit in the mid-range is delayed by about 90° with respect to the phase of the second speaker unit, but the delay may be designed appropriately according to the arrangement position relationship of the speaker units as described above, and is not limited to about 90°. For example, as the distance pitch d2 in the depth direction between the first speaker units 2 and 5 and the second speaker units increases, the phase delay thus given may be decreased.

Further, depending on a positional relationship of the arrangement of the speaker units, the phase may be advanced. In short, a phase difference may be designed so that the sound arriving from the first speaker unit of one of the speaker system closer to the listening position and the sound arriving from the second speaker unit of the same speaker system are destructive to each other in the mid-range, whereby the sound pressure in the mid-range arriving from the speaker system closer to the listening position attenuates more, as compared with the sound pressure in the mid-range arriving from the speaker system farther from the listening position. However, in the case where the phase delay is designed so as to be about 90° as in the present embodiment, the designing of the positional relationship of the arrangement of the network circuit and the speaker units is facilitated. The designing is facilitated by setting the phase delay in a range of about 90°+45°.

Still further, since the present embodiment is configured such that the difference between the distances L2 and L3 and the difference between the distances L5 and L6 become equal when the listening position P is located in the front direction of one speaker system 1, it is optimal to provide the phase difference of 90°. This configuration facilitates the designing of the network circuit.

Still further, as the distance between the speaker units in the width direction or the depth direction is increased, the central frequency (about 2 kHz in the present embodiment) at which the foregoing action and effect can be achieved is decreased. It is desirable that the central frequency should not be deviated largely from the frequency band most effective for the center sound image localization with respect to voice.

It should be noted that as the distance pitch d1 between the first speaker units 2 and 5 and the second speaker units 3 and 6 in the horizontal direction is increased, the effect of decreasing the sound pressure vector V1 of the speaker system 1 closer to the listening position P as compared with the sound pressure vector V2 of the speaker system 4 farther from the listening position P can be achieved with a lower frequency.

In the present embodiment, the 6-dB/oct-type network circuit is used, but needless to say, another circuit configuration such as a 12-dB/oct-type may be used. In such a case, since the value of phase rotation varies with the network circuit, the value may be designed appropriately along with the positional relationship of the arrangement of the speaker units. It should be noted that, however, an excessively high-order filter circuit has a steep slope, thereby causing a large phase rotation. Therefore, a 6-dB/oct-type having a gentle slope, or a 12-dB/oct-type having a low Q, is suitable.

### EMBODIMENT 2

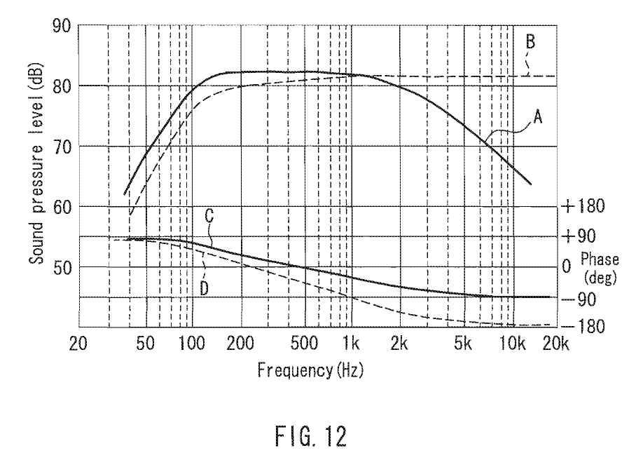

FIG. 11 is a network circuit diagram of a speaker device according to Embodiment 2 of the present invention. FIG. 12 is a frequency characteristic diagram of each speaker unit of the speaker device according to Embodiment 2 of the present invention. In the present embodiment, a cabinet of the speaker system and specifications and arrangement of the speaker units 2, 3, 5, and 6 are similar to those of Embodiment 1.

Embodiment 2 is different from Embodiment 1 in that the first speaker units 2 and 5 are not sealed on the back and reproduce bass-range sounds, and are also different in the polarities of the first speaker units 2 and 5 and the network circuit configuration.

As shown in FIG. 11, the treble range of the second speaker units 3 and 6 is attenuated by a 6-dB/oct-type network circuit composed of a treble-cutting coil L1. This point is similar to that of Embodiment 1, but in the present embodiment, a network circuit for each of the first speaker units 2 and 5 is a phase-shift circuit composed of two capacitors C and two coils L2. The first speaker units 2 and 5 and the second speaker units 3 and 6 are connected to the network circuits, with the same polarities. In FIG. 11, input signals are supplied to input terminals (+) and (−), after being amplified by an amplifier circuit (not shown) in a previous stage.

In other words, as shown in FIG. 12, the first speaker units 2 and 5 reproduce an entire band from the bass range to the treble range, but the phase in the mid-range to the treble range is delayed by the phase-shift circuit of the network, and the phase is inverted in the treble range.

Frequency characteristics of the speaker units 2, 3, 5, and 6 at the same measurement distances on the axes are as shown in FIG. 12. A sound pressure frequency characteristic of the first speaker units 2 and 5 is indicated with a broken line B, and a phase frequency characteristic thereof is indicated with a broken line D. A sound pressure frequency characteristic of the second speaker units 3 and 6 is indicated with a solid line A, and a phase frequency characteristic thereof is indicated with a solid line C. The reason why the sound pressure in the bass range of the first speaker units 2 and 5 is slightly lower than the sound pressure in the bass range of the second speaker units 3 and 6 is that the diameter of each of the first speaker units 2 and 5 is small.

According to the configuration of the present embodiment, the same frequency characteristics in the mid-range to the treble range as those of Embodiment 1 are obtained. Therefore, in the mid-range to the treble range, the same action and effect as those of Embodiment 1 described above are achieved also in the present embodiment. Further, since the first speaker units 2 and 5 reproduce the bass range in the present embodiment, there is no need to seal the first speaker units 2 and 5 on the back.

By configuring the speaker device of Embodiment 2 as described above, the speaker device achieves the following effect in addition to the effects of Embodiment 1 described above: since there is no need to seal the first speaker units 2 and 5 on the back, the internal configuration of each of the speaker systems 1 and 4 can be simplified.

It should be noted that in the present embodiment, for example, each of the first speaker units 2 and 5 has a diameter of 6.5 cm and each of the second speaker units 3 and 6 has a diameter of 8 cm, but each of the speaker units 2, 3, 5, and 6 may be, for example, full-range-type units in the same specification. With this configuration, it is possible to simplify the configuration of the speaker systems 1 and 4.

### EMBODIMENT 3

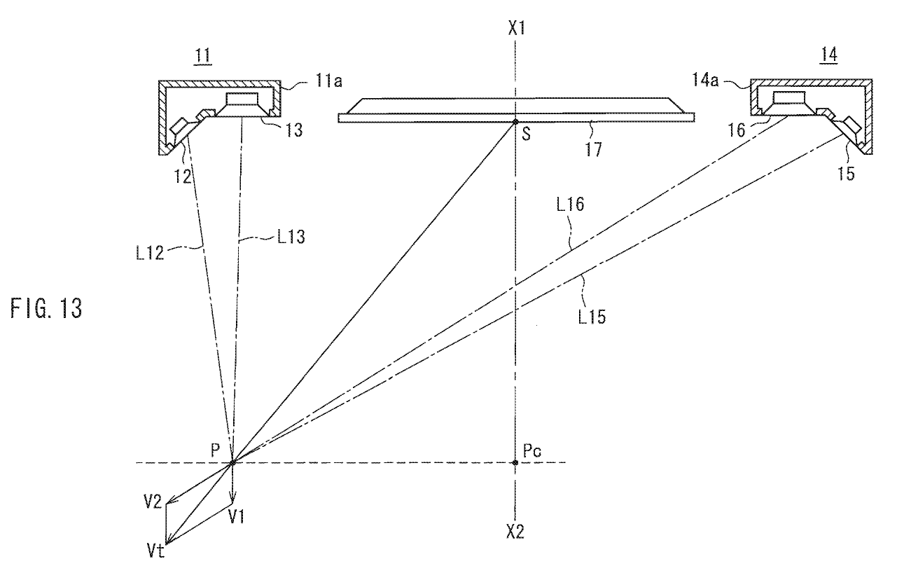

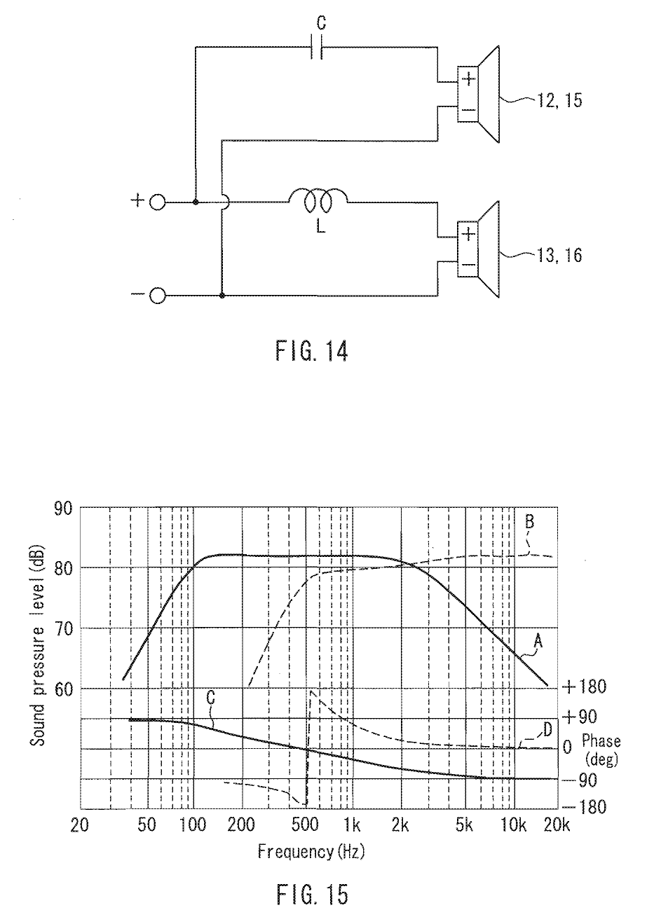

FIG. 13 is a speaker unit arrangement diagram of a speaker device according to Embodiment 3 of the present invention. FIG. 14 is a network circuit diagram of the foregoing speaker device. FIG. 15 is a frequency characteristic diagram of each speaker unit of the speaker device. In FIG. 13, first speaker units 12 and 15, second speaker units 13 and 16, and a display 17 are similar to those of Embodiment 1, respectively; therefore, descriptions of the same are omitted herein.

Embodiment 3 is different from Embodiment 1 in the each shape of speaker systems 11 and 14, i.e., the each shape of cabinets 11a and 14a, the arrangement relationship of the speaker units 12, 13, 15, and 16, and polarities of the first speaker units 12 and 15. The first speaker units 12 and 15 are sealed on the back as in Embodiment 1.

The first speaker units 12 and 15 are arranged on outer sides with respect to the second speaker units 13 and 16, respectively, and are arranged so as to emit sounds in inward directions. The second speaker units 13 and 16 are arranged so as to emit sounds in the front direction, and so emit sounds in outward directions as compared with the first speaker units 12 and 15, respectively. Each angle of the sound emission directions of the first speaker units 12 and 15 with respect to the listening center axis X1-X2 is approximately 45°, i.e., the same as that of Embodiment 1.

A distance pitch in the horizontal direction between the first speaker units 12 and 15 and the second speaker units 13 and 16 is approximately 9 cm, which is the same as that of Embodiment 1. Besides, a distance pitch thereof in the depth direction is approximately 4 cm, which is the same as that of Embodiment 1 also. The first speaker units 12 and 15 and the second speaker units 13 and 16 are arranged horizontally, i.e., in the same manner as that in Embodiment 1. The position relationship of the speaker systems 11 and 14, the center listening position Pc, and the listening position P is similar to that of Embodiment 1.

As shown in FIG. 14, the network circuit of the present embodiment has the same circuit configuration as that of Embodiment 1, except that the first speaker units 12 and 15 are connected to the network circuit with the same polarity as that of the second speaker units 13 and 16.

Frequency characteristics of the speaker units 12, 13, 15, and 16 at the same measurement distances on the axes are as shown in FIG. 15. A sound pressure frequency characteristic of the first speaker units 12 and 15 is indicated with a broken line B, and a phase frequency characteristic thereof is indicated with a broken line D. A sound pressure frequency characteristic of the second speaker units 13 and 16 is indicated with a solid line A, and a phase frequency characteristic thereof is indicated with a solid line C.

As is clear from FIG. 15, in the present embodiment, contrary to Embodiment 1, the phase of an emitted sound in the mid-range to the treble range of the first speaker units 12 and 15 is advanced by approximately 90° as compared with the phase of an emitted sound of the second speaker units 13 and 16.

With the above-described configuration, the same action and effect as those of Embodiment 1 described above can be achieved. This is because the first speaker units 12 and 15 are arranged on outer sides with respect to the second speaker units 13 and 16, respectively, in the present embodiment. With this arrangement, a distance L15 to the listening position P from the first speaker unit 15 of the speaker system 14 farther from the listening position P becomes about 4 cm longer than a distance L16 from the second speaker unit 16 to the listening position P.

Since the phase of an emitted sound of the first speaker unit 15 advances by about 90° originally in the mid-range as compared with the phase of an emitted sound of the second speaker unit 16, the phase difference between the foregoing sounds when the sounds arrive at the listening position P decreases. Accordingly, the phase difference between the arriving sound from the first speaker unit 15 and the arriving sound from the second speaker unit 16 approaches 0°, whereby both the emitted sounds are constructive to each other.

On the other hand, a distance L12 to the listening position P from the first speaker unit 12 of the speaker system 11 closer to the listening position P is about 4 cm shorter than a distance L13 to the listening position P from the second speaker unit 13.

Since the phase of an emitted sound of the first speaker unit 12 advances by about 90° originally in the mid-range as compared with the phase of an emitted sound of the second speaker unit 13, the phase difference between the foregoing sounds when the sound arrive at the listening position P increases. Accordingly, the phase difference between the arriving sound from the first speaker unit 15 and the arriving sound from the second speaker unit 16 approaches 180°, whereby both the emitted sounds are destructive to each other

Thus, the completely same action and effect as those of Embodiment 1 described above can be achieved in the present embodiment. Besides, in the present embodiment, since the first speaker units 13 and 16 are arranged on outer sides with respect to the first speaker units 12 and 15, respectively, the emitted sounds of the first speaker units 12 and 15 become less obstructed by the display. Therefore, the speaker systems 11 and 14 can be disposed further back.

Therefore, in addition to the effect of Embodiment 1 described above, the speaker device of the present embodiment can achieve the effect that the speaker systems 11 and 14 can be disposed more backward, whereby the degree of freedom in the arrangement is increased.

### EMBODIMENT 4

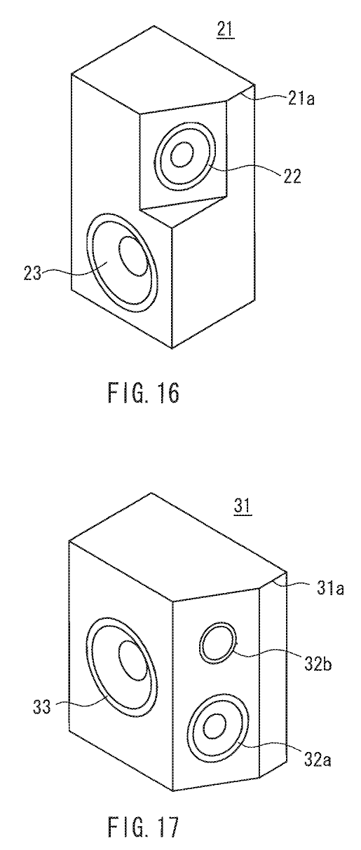

FIG. 16 is a perspective view of a left-side speaker system 21 composing a speaker device according to Embodiment 4 of the present invention. A first speaker unit 22 and a second speaker unit 23 are arranged so that the first speaker unit 22 emits sounds in an inward direction and the second speaker unit emits sounds toward the vicinity in a front direction. Further, the first speaker unit 22 and the second speaker unit 23 are attached to a cabinet 21a so that they are arranged in a vertical relationship.

The configuration of each of the speaker units 22 and 23 has the same specification of that of Embodiment 1 described above. Besides, the configuration of the network circuit is the same as that of Embodiment 1, too.

This configuration makes it possible not only to achieve the same action and effect of the present invention as described above, but also to downsize the speaker system 21 in the width direction.

Further, it should be noted that, for example, the first speaker unit 22 has a diameter of 6.5 cm and the second speaker unit has a diameter of 8 cm in the present embodiment, but it is possible to reduce dimensions in the width direction of the speaker system further, by decreasing the diameter of the second speaker unit, or the like.

### EMBODIMENT 5

FIG. 17 is a perspective view of a left-side speaker system 31 composing a speaker device according to Embodiment 5 of the present invention. The shape of a cabinet 31a and the configuration of a second speaker unit 33 are similar to those of Embodiment 1.

In the present embodiment, a first speaker unit has a multiway configuration, and is composed of a bass-range side part 32a of the first speaker unit and a treble-range side part 32b of the first speaker unit. For example, the bass-range side part 32a of the first speaker unit is a 6.5-cm-diameter mid-range unit, while the treble-range side part 32b of the first speaker unit is a 2.5-cm-diameter dome-shaped tweeter. They have a crossover frequency at about 8 kHz.

With this configuration, not only the action and effect of the present invention described above, but also the improvement of sound quality itself can be achieved. In other words, when the first speaker unit is only one, a full-range unit or a unit for the mid-range to the treble range having a diameter of about several centimeters is used in many cases, and hence, the reproduction capability and the sound quality in a band with high frequencies in the treble range sometimes are not sufficient. In the present embodiment, since the tweeter for exclusive use can be used as the treble-range side part 32b of the first speaker unit, the excellent sound quality can be obtained in the treble range.

It should be noted that in this case, consideration has to be given to a lower range part of a reproduction frequency band for the high-range side part 32b of the first speaker unit, that is, the crossover frequency. This is because, since the small-diameter tweeter has a wide directivity, if the crossover frequency is set excessively low, this decreases the effect of significantly decreasing the sound pressure in the treble range arriving to the listening position from the first speaker unit closer thereto as compared with the sound pressure in the treble range arriving to the listening position from the first speaker unit farther therefrom.

Therefore, in the present embodiment, for example, the crossover frequency is set to 8 kHz, which is a frequency such that ka=2 (k is a wavelength constant, a is an effective vibrating radius) is satisfied with respect to an effective vibrating radius of a 2.5-cm-diameter dome-type tweeter, whereby the directivity begins narrowing.

### EMBODIMENT 6

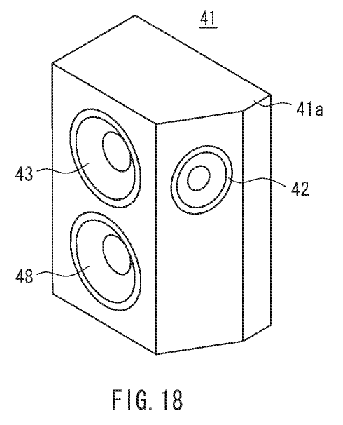

FIG. 18 is a perspective view of a left-side speaker system 41 composing a speaker device according to Embodiment 6 of the present invention. The horizontal in-plane shape of the cabinet 41a, as well as a first speaker unit 42 and a second speaker unit 43 are similar to those of Embodiment 1, and the arrangement position relationship is similar to that of Embodiment 1, too. A network circuit thereof also is similar to that of Embodiment 1.

In the present embodiment, the first speaker unit 42 and the second speaker unit 43 are used as a center speaker for multichannel reproduction, and they are integrated with a speaker unit 48 of a front speaker system for multichannel reproduction, thereby configuring the speaker device. The speaker unit 48 is, for example, a full-range unit having a diameter of 8 cm.

With this configuration, not only the same action and effect of the present invention as those described above are achieved, but also a simple speaker device for multichannel reproduction can be obtained, in which an independent center speaker does not have to be installed.

### EMBODIMENT 7

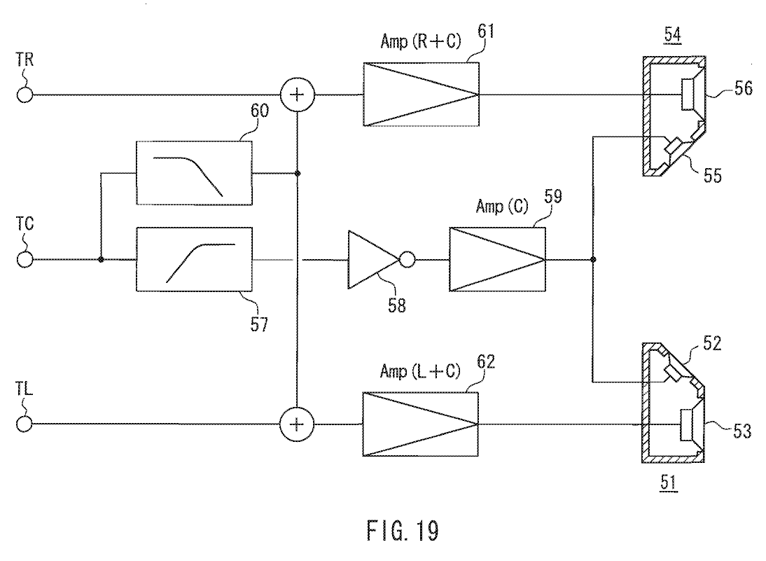

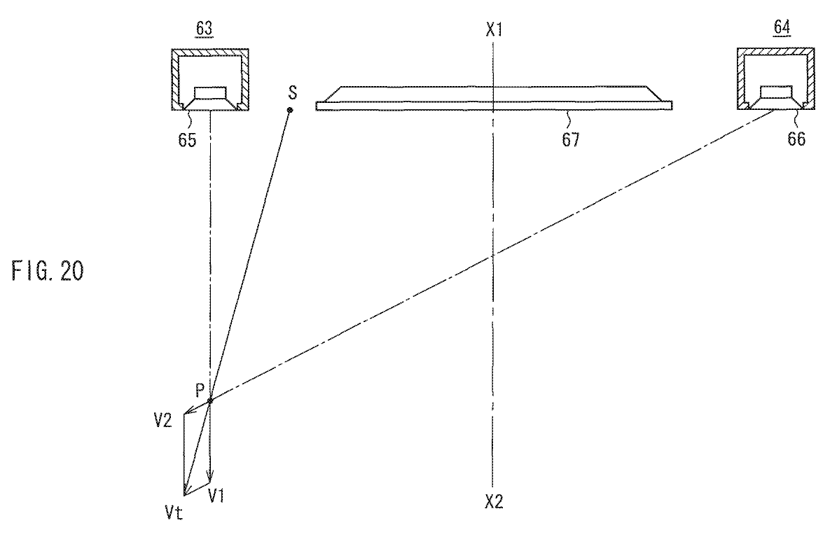

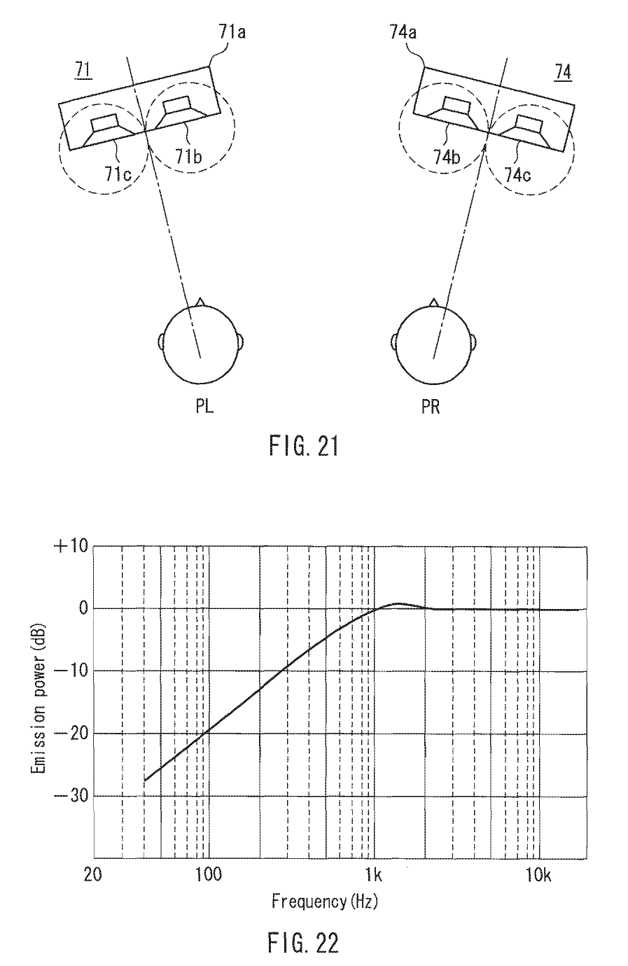

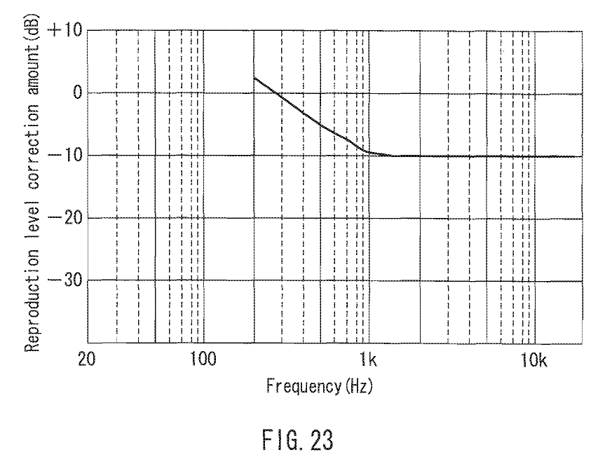

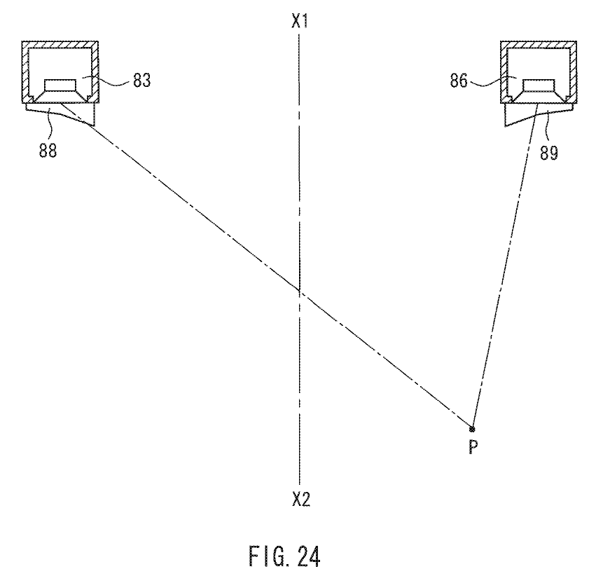

FIG. 19 shows a configuration of a speaker device according to Embodiment 7 of the present invention. In FIG. 19, in a left-side speaker system 51, a first speaker unit 52 and a second speaker unit 53 are installed. In a right-side speaker system, a first speaker unit 55 and a second speaker unit 56 are installed. The arrangement relationship of the first speaker units 52 and 55 and the second speaker units 53 and 56 is similar to that of Embodiment 1.

In the present embodiment, however, each of the first speaker units 52 and 55 is, for example, a 6.5-cm-diameter fill-range unit, and each of the second speaker units 53 and 56 is, for example, a 8-cm-diameter full-range unit.

A center channel signal supplied to a terminal TC is divided into signals for two paths. A center channel signal supplied to one of the two paths is inputted to a 6-dB/oct-type high-pass filter 57, so that the mid-range and the treble range thereof are passed through, then a phase thereof is inverted by an inverter 58, and an output signal is fed to an amplifier (C) 59, so as to drive the first speaker units 52 and 55. A center channel signal supplied to the other path is inputted to a 6-dB/oct-type low-pass filter 60, so that the treble range thereof is attenuated, then the signal is fed to amplifiers (R+C) 61 and (L+C) 62, so as to drive the second speaker units 53 and 56. In other words, the high-pass filter 57 and the low-pass filter 60 adjust the frequency characteristic of the center signal channel signal supplied to the terminal Tc.

A front R channel signal and a front L channel signal fed via terminals Tr and T1 are fed to the amplifier (R+C) 61 and the amplifier (L+C) 62, respectively, and are reproduced by the second speaker units 53 and 56, respectively In other words, each of the second speaker units 53 and 56 is configured so as to be supplied with the center channel signal with treble range having been attenuated and the front channel signal are fed thereto in a superimposed state, and reproduce both signals.

With this configuration, as to the center channel signal, the characteristics of input signals applied to the first speaker units 52 and 55 and the second speaker units 53 and 56 are similar to those of Embodiment 1 described above. Therefore, the action and effect of the present invention are exhibited with respect to the center channel signal, whereby an excellent effect of expanding the listening position range in which the center sound image localization can be achieved with respect to audio signals on the center channel can be achieved.

With the above-described configuration, a speaker device that reproduces the center channel and the front L and R channels with a total of four of speaker units, which is the minimum number of speaker units, can be obtained.

With the present embodiment, since the center speaker system is configured integrally with the front speaker system, there is no need to install an independent center speaker system. In addition, it is possible to obtain a low-cost and small-size speaker device for multichannel reproduction with which an excellent effect of the center sound image localization can be achieved with respect to audio signals on the center channel.

It should be noted that by arranging the speaker device of the present invention symmetrically in the vertical direction as well, sound images can be localized at the center in the vertical direction as well, in addition to the effect of the center sound image localization in the horizontal direction.

Needless to say, the present invention is not limited to the examples of the above-described embodiments.

### INDUSTRIAL APPLICABILITY

With the speaker device of the present invention, it is possible to achieve an excellent effect of expanding the listening position range in which the center sound image localization can be achieved with respect to a voice such as singing voice or speech also, to obtain natural sound quality that does not cause sense of discomfort, to perform the large sound pressure reproduction, and to downsize the device. Therefore, the speaker device of the present invention is useful, not only for sound reproduction of general two-channel stereophonic reproduction equipment or multichannel sound reproduction equipment, but also for sound reproduction of electronic equipment in general, such as sound reproduction equipment for television, on-vehicle sound reproduction equipment, sound reproduction equipment built in personal computers, and portable sound reproduction equipment.

1. A speaker device comprising:
a pair of speaker systems, each speaker system having a first speaker unit and a second speaker unit; and
a signal adjustment part for adjusting a frequency characteristic of an input signal,
the first speaker units being arranged symmetrically with respect to a listening center axis, and the second speaker units being arranged symmetrically with respect to the listening center axis, when the pair of speaker systems are arranged symmetrically with respect to the listening center axis,
wherein the first and second speaker units are arranged so that the first speaker unit emits a sound in an inward direction, and the second speaker unit emits a sound in a front direction of the speaker system or in an outward direction as compared with the direction of the first speaker unit, where the inward direction is defined as a direction in which the listening center axis is viewed from each speaker system,
the signal adjustment part is configured so as to adjust the input signal so that the first speaker unit emits a sound at least in a mid-range and above; the second speaker unit emits a reproduction sound whose treble range is attenuated; and, with respect to a listening position in a front direction of one of the speaker systems, a sound arriving to the listening position from the first speaker unit of the speaker system located closer to the listening position, and a sound arriving to the listening position from the second speaker unit of the same speaker system, are destructive to each other in the mid-range owing to a phase difference between the sounds,
whereby a sound pressure in the mid-range arriving from the speaker system located closer to the listening position is attenuated more, as compared with a sound pressure in the mid-range arriving from the speaker system located farther from the listening position.

2. The speaker device according to claim 1, wherein the mid-range is set to a frequency range including a part or an entirety of the second formant frequency and the third formant frequency of human voice.

3. The speaker device according to claim 1, wherein
the first speaker unit is arranged on an inner side with respect to the second speaker unit as viewed from the listening center axis, and
in the mid-range, a phase of an emitted sound of the first speaker unit is delayed as compared with a phase of an emitted sound of the second speaker unit.

4. The speaker device according to claim 1, wherein
the first speaker unit is arranged on an outer side with respect to the second speaker unit as viewed from the listening center axis, and
in the mid-range, a phase of an emitted sound of the first speaker unit is advanced as compared with a phase of an emitted sound of the second speaker unit.

5. The speaker device according to claim 1, wherein a bass range of the first speaker unit is attenuated.

6. The speaker device according to claim 1, wherein the first speaker unit and the second speaker unit are arranged in a vertical relationship.

7. The speaker device according to claim 1, wherein the first speaker unit has a multiway configuration.

8. The speaker device according to claim 1, wherein the speaker systems function as a center speaker for multichannel reproduction, thereby having a configuration in which a front speaker system and the center speaker for multichannel reproduction are integrated.

9. The speaker device according to claim 8, wherein a center channel signal with treble range being attenuated, and a front channel signal are supplied in a superimposed state to the second speaker unit.
